(19) United States
(12) Patent Application Publication
(10) Pub. No.: US 2006/0130148 A1
(43) Pub. Date: Jun. 15, 2006

(54) Fingerprinting code structure and collusion customer identifying method using the same

(76) Inventors: Won Gyum Kim, Taejon (KR); Young Ho Suh, Taejon (KR)

Correspondence Address: MAYER, BROWN, ROWE & MAW LLP, 1909 K STREET, N.W., WASHINGTON, DC, 20006, US

(21) Appl. No.: 11/023,393

(22) Filed: Dec. 29, 2004

(30) Foreign Application Priority Data
Nov. 24, 2004 (KR) 2004-97114

(51) Int. Cl. H04N 7/16

(52) U.S. Cl. 726/26

(57) ABSTRACT

A fingerprint code structure and a collusion customer identifying method using the same are disclosed. The collusion customer identifying method includes the steps of: inserting a fingerprint code including a contents code and a customer code in a contents; extracting the fingerprint code; determining whether there is an collusion attack on the contents by using the extracted fingerprint code; and identifying the collusion customers participating in the collusion attack according to a result of the determination. The collusion customer identifying method can trace collusion customers participating in the collusion attack by using a location of undetectable code although the collusion customers eliminate the fingerprint code from the multimedia contents by participating in the collusion attack.

### BACKGROUND OF THE INVENITON

1. Field of the Invention

The present invention relates to a fingerprinting code structure and a collusion customer identifying method using the same, and more particularly, to a fingerprinting code structure and a collusion customer identifying method using the same for tracing customers participating a collusion by differently allocating a location of a code eliminated after a collusion attack according to customers.

2. Description of the Related Art

Generally, a watermarking technology and a fingerprinting technology have been used for protecting a copyright of multimedia contents and they are very similar in a view of inserting/extracting side information such as a noise to/from the multimedia contents. In the fingerprinting technology, a fingerprint code is inserted or extracted by using a conventional inserting/extracting method of the watermarking technology and the inserted fingerprint code is not recognized by the customers. However, the inserted side information is different between the watermarking technology and the fingerprint technology. In the watermarking technology, information of copyright of the content is inserted into the multimedia contents. In contrary, in the fingerprint technology, information of a customer regally purchasing the multimedia contents is inserted. In the fingerprint technology, the customer information is inserted for tracing of legal customer from illegally distributed multimedia contents and it is an object of the fingerprint technology. By using the fingerprint code inserted in the multimedia contents, it can determine whether an owner of the multimedia contents is a regal purchaser of the multimedia contents and it can trace a customer illegally distributing the multimedia contents.

However, identical multimedia contents have different fingerprint codes in the fingerprinting technology since customers of the multimedia contents are different. By using this, ill-intentioned customers may try to extract the inserted fingerprint code from the multimedia contents. It is commonly called as a collusion attack. That is, two or more customers compare purchased multimedia contents and find a location of the fingerprint code and a comparative value. By using the found location of the fingerprint code and the found comparative value, the fingerprint code may be extracted from the multimedia contents without seriously degrading a quality of the multimedia contents.

For overcoming the above-mentioned drawback of the conventional fingerprinting technology, an anti-collusion code (ACC) has been introduced. In accordance with the ACC, a predetermined code is extracted from the multimedia contents when the ill-intentioned customers try the collusion attack to the multimedia contents. By using the extracted predetermined code, collusion customers participating in the collusion attack can be identified.

The conventional ACC uses a method allocating a unique code to all collusion attacks. The collusion attack would be fail, if identical code value is inserted to identical location of the contents when the collusion attack is tried. That is, if a location of code is ‘1’ where the identical code value is inserted, locations of ‘1’ are differently arranged according to all collusions.

A d-detecting code has been introduced in an article by J. Dttmann, entitled “Combining digital watermarks and collusion secure fingerprints for customer copy monitoring,” Proc. IEEE seminar Sec. Image & Image Auth, pp. 128-132, March 2000. By using the d-detecting code, all collusion customers can be traced when the number of collusion customers is limited to two. That is, the d-detecting code is the ACC designed to tracing collusion customers when the number of attackers is d based on the finite projective geometry. For example, if the number of the collusion attackers is two, fingerprint codes of three customers are shown below.

V1={1, 0, 0, 0, 1, 1, 0}

V2={1, 1, 1, 0, 0, 0, 0}

V3={0, 0, 1, 1, 1, 0, 0}

As shown, there are similar parts in the fingerprint codes of the three customers V1, V2 and V3 according to each collusion. That is, values in the first locations of the fingerprint codes are identical between V1 and v2 and values in third locations of fingerprint codes are identical between V2 and V3. Finally, values in fifth locations of the fingerprint codes are identical between V1 and V3. A value ‘1’ in the code means insertion of fingerprint code and ‘0’ means no fingerprint code inserted. If the customer V1 and the customer V2 participate to the collusion attack, fingerprint codes located locations 2, 3, 5 and 6 may be eliminated because of its difference. However, fingerprint code located at the location 1 cannot be eliminated because there is no difference between location 1 of V1 and location 1 of V2. If a fingerprint code is extracted from a location 1 from collusion contents, it represents that the customer V1 and the customer V2 are participated to collusion attack.

A K-resilient AND-ACC code generation method has been introduced in an article by W. Trappe, M. Wu, Z. J. Wang, and K. J. R Liu, entitled “Anti-collusion Fingerprinting for Multimedia”, IEEE Trans. On Signal Processing, Vol. 51, pp. 1069-1087, April 2003. In the introduced method, the K-resilient AND-ACC code is generated by using a balanced incomplete block designs (BIBD). K is the number of collusion customers participating a collusion attack and an operator of collusion is “AND”. The K-resilient AND-ACC code is designed to generate a unique code set from all collusion attacks with the number of customers participating the collusion attack is K or less than K. Based on the extracted code, collusion customers participating in the collusion attacks can be identified. In the K-resilient AND-ACC, n is the number of codes possibly distributed and n is defined as (l²−l)/c²+c) where l is a length of code and c is the number of collusion customers participating to the collusion attack.

When two collusion customers participate in the collusion attack among seven customers, an example of code that can trace collusion customers is shown below.

$$[ \begin{matrix}0 & 0 & 0 & 1 & 1 & 1 & 1 \\ 0 & 1 & 1 & 0 & 0 & 1 & 1 \\ 1 & 0 & 1 & 0 & 1 & 0 & 1 \\ 0 & 1 & 1 & 1 & 1 & 0 & 0 \\ 1 & 1 & 0 & 0 & 1 & 1 & 0 \\ 1 & 0 & 1 & 1 & 0 & 1 & 0 \\ 1 & 1 & 0 & 1 & 0 & 0 & 1\end{matrix} ]$$

A column represents customers and there are two identical parts in two columns. For example, fifth and seventh bits are ‘1’ in the first and the second columns, and second and seventh bits are ‘1’ in the second and the seventh columns. If code of {0, 0, 0, 0, 1, 0, 1} is extracted as the fingerprint code, it the code represents that the first customer and the second customer are participated to the collusion attack.

As mentioned above, it is common among the conventional ACCs that a location of ‘1’ at the extracted code is unique according to all collusions. Accordingly, the collusion customers may be easily identified because the extracted code is unique and the unique extracted code represents a specific collusion. However, in the conventional ACCs, a length of code exponentially increases in corresponding to the number customers possible to participate in the collusion attack. Therefore, the above-mentioned conventional ACCs may not be implemented to the multimedia content having limited size.

### SUMMARY OF THE INVENTION

Accordingly, the present invention is directed to fingerprinting code structure and a collusion customer identifying method using the same.

It is an object of the present invention to provide a fingerprint code structure inserted to multimedia contents for protecting a copyright of the multimedia contents selling in on-line.

It is another object of the present invention to provide a collusion customer identifying method for tracing and identifying collusion customers by using a location of undetectable code.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, there is provided a fingerprint code structure including: a contents code for indexing a contents itself; and a customer code for having an index location representing a customer and remained locations.

In another aspect of the present invention, there is provided a method for identifying collusion customers by using a fingerprint code, the method including the steps of: a) inserting a contents code having same value to identical contents; b) extracting the contents code from the contents and using the extracted contents code as a signal mark for determining whether a customer code is included in the contents; and c) determining all customers as collusion customers participating in the collusion attack when the contents only includes the contents code.

In still another aspect of the present invention, there is provided a method for identifying collusion customers by using a fingerprint code, the method comprising the steps of: a) inserting a customer code having different value in a contents; b) extracting the customer code; c) indexing a customer to a location of undetectable code in the customer code; and d) identifying collusion customers by using locations of undetectable code from the contents where the customer code is eliminated by the collusion attack.

In further still another aspect of the present invention, there is provided a method for identifying collusion customers by using a fingerprint code, the method including the steps of: a) inserting a fingerprint code including a contents code and a customer code in a contents; b) extracting the fingerprint code; c) determining whether there is an collusion attack on the contents by using the extracted fingerprint code; and d) identifying the collusion customers participating in the collusion attack according to a result of the determination.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention, are incorporated in and constitute a part of this application, illustrate embodiments of the invention and together with the description serve to explain the principle of the invention. In the drawings:

FIG. 1 is a block diagram illustrating a fingerprint system in accordance with a preferred embodiment of the present invention;

FIG. 2 is a diagram showing a fingerprint code structure in accordance with a preferred embodiment of the present invention;

FIG. 3 is a table showing lengths of fingerprint codes and computation complexities of the present invention and a related art;

FIG. 4 is a flowchart showing a method for identifying collusion customers by using a contents code in accordance with a preferred embodiment of the present invention;

FIG. 5 is a flowchart showing a method for identifying collusion customers by using a customer code in accordance with a preferred embodiment of the present invention; and

FIG. 6 is a flowchart illustrating a method for identifying collusion customers by using a fingerprint code in accordance with a preferred embodiment of the present invention.

### DETAILED DESCRIPTION OF THE INVENTION

Reference will now be made in detail to the preferred embodiments of the present invention, examples of which are illustrated in the accompanying drawings.

FIG. 1 is a block diagram illustrating a fingerprint system in accordance with a preferred embodiment of the present invention.

As shown in FIG. 1, the fingerprint system includes a fingerprinting unit 100 for generating a fingerprint and inserting the generated fingerprint to a multimedia contents and a fingerprint extracting unit 200 for extracting the inserted fingerprint from the multimedia contents and identifying the collusion customer.

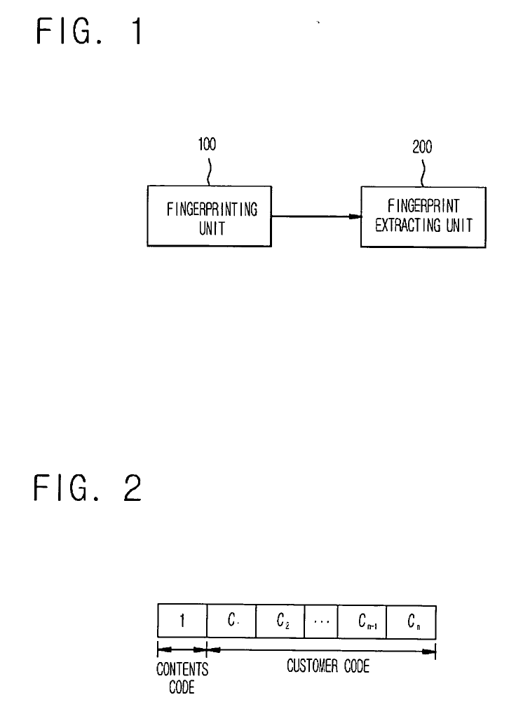

FIG. 2 is a diagram showing a fingerprint code structure in accordance with a preferred embodiment of the present invention.

As shown in FIG. 2, the fingerprint code includes a contents code and a customer code.

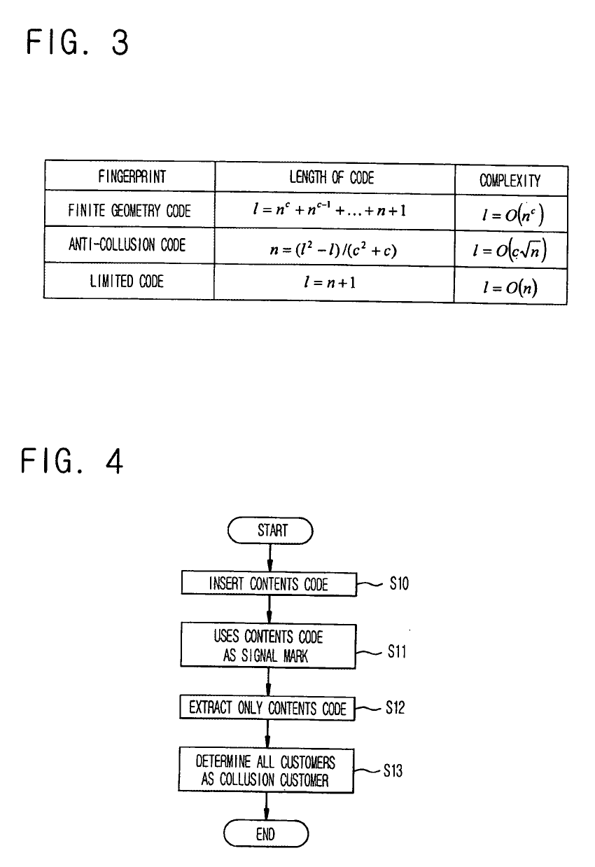

Hereinafter, a method for identifying a collusion customer by using the fingerprint code shown in FIG. 2 is explained by referring to FIGS. 3 to 6.

At first, the fingerprinting code structure is explained in accordance with a preferred embodiment of the present invention.

The contents code of the fingerprint code is inserted for indexing the contexts itself or is used as a signal mark for proving insertion. of the fingerprinting code when all customer codes are eliminated. That is, if the signal mark is only extracted by extracting the fingerprint code, it means that all customers participate in the collusion attack. Generally, same value is inserted to identical multimedia contents so the collusion attack is not occurred. A location of contents code may be in front of the customer code, in back of the customer code, or in middle of the customer code.

The customer code Ci of the fingerprint code is defined as follows.

Ci={C1, C2, . . . , Cn}, i=index of customer

Cn=0, if(n=index of customer)

1, otherwise

The n is the number of customers possible to illegally distribute the multimedia contents.

A code ‘0’ is inserted at a location of an index of customer in the customer code and a code ‘1’ is inserted remained locations of the customer code. If there are eight customers, a fingerprint code of the present invention may have following code values.

Customer 1 (C1): 1 0 1 1 1 1 1 1 1

Customer 2 (C2): 1 1 0 1 1 1 1 1 1

Customer 3 (C3): 1 1 1 0 1 1 1 1 1

Customer 4 (C4): 1 1 1 1 0 1 1 1 1

Customer 5 (C5): 1 1 1 1 1 0 1 1 1

Customer 6 (C6): 1 1 1 1 1 1 0 1 1

Customer 7 (C7): 1 1 1 1 1 1 1 0 1

Customer 8 (C8): 1 1 1 1 1 1 1 1 0

A length l of the generated fingerprint code is n+1 and a complexity of computation is O(n).

As shown above, identification of customer is determined by the location of ‘0’ in the fingerprint code. In case of first customer 1, second location of the fingerprint code is only ‘0’ and remained locations of the fingerprint code are all ‘1’s. Similarly, the fingerprint codes of the other customers have ‘0’ at the index location and remained locations are all ‘1’.

In case of the first customer 1 and the second customer 2 participate in the collusion attack, code values of the second location and the third location are eliminated because they are different each other. Remained bits of code value are not different so the collusion attack cannot be occurred. Finally, the fingerprint extracting unit extracts a code of {1××1 1 1 1 1}. X is an undetected part of code (undetectable code) in the fingerprint code. Accordingly, based on the locations of Xs, the first customer 1 and the second customer 2 are identified as collusion customers. In the worst case, the fingerprint extracting unit extracts a code of {1, x, x, x, x, x, x, x, x}.

That is, the customer code is not extracted excepting a contents code from the fingerprint code. It represents that all customers participate in the collusion attack.

Hereinafter, a method for identifying collusion customers in accordance with a preferred embodiment of the present invention.

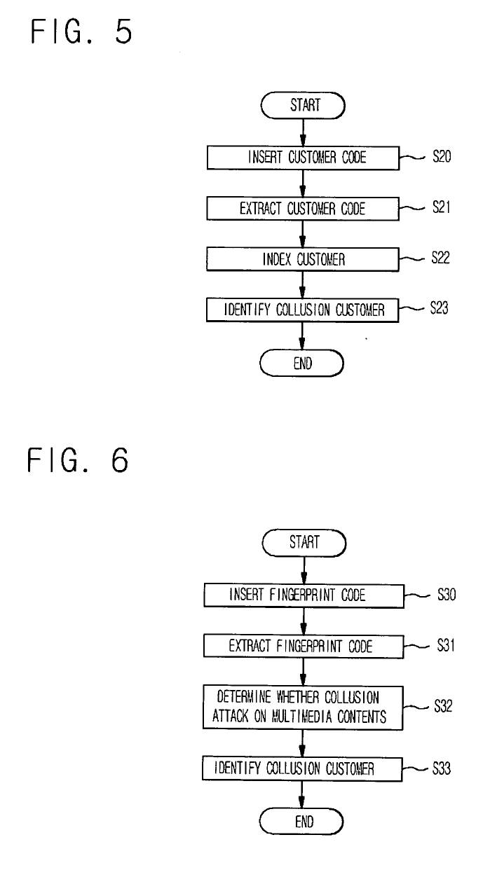

FIG. 4 is a flowchart showing a method for identifying collusion customers by using a contents code in accordance with a preferred embodiment of the present invention, and FIG. 5 is a flowchart shown a method for identifying collusion customers by using a customer code in accordance with a preferred embodiment of the present invention.

As first, the method for identifying collusion customers by using the contents code shown in FIG. 4 is explained.

The fingerprinting unit 100 inserts a contents code having a same predetermined value into identical multimedia contents at step S10. The fingerprint extracting unit 200 firstly extracts the contents code from the multimedia contents and uses the extracted contents code as a signal mark for determining whether a customer code is included in the multimedia contents at step S11. If there is only the contents code included at step S12, it determines that all customers participate in the collusion attack at step S13. That is, it determines that all customers are collusion customers at step S13.

Hereinafter, a method for identifying collusion customers by using the customer code shown in FIG. 5 is explained.

The fingerprinting unit 100 inserts a customer code having different values in the multimedia contents at step S20. The fingerprint extracting unit 200 extracts the customer code from the multimedia contents at step S21 and indexes customers to locations of undetectable code in the customer code at step S22. The fingerprint extracting unit 200 identifies collusion customers participating in the collusion attack by using the location of undetectable code from the multimedia contents where the customer code is eliminated by the collusion attack at step S23.

FIG. 6 is a flowchart showing a method for identifying collusion customers by using a fingerprint code in accordance with a preferred embodiment of the present invention.

The fingerprinting unit 100 inserts the fingerprint code including a contents code and a customer code into a multimedia content at step S30. The fingerprint extracting unit 200 extracts the fingerprint from the multimedia content at step S31. The fingerprint extracting unit 200 determines whether there is a collusion attack at the multimedia content at step S32. All customers participating in the collusion attack are identified according to a result of the determination at step S33.

As mentioned above, the fingerprint code structure and the method for identifying collusion customer by using the same of the present invention can trace customers participating in the collusion attack by using a location of undetectable code although the collusion customers eliminate the fingerprint code from the multimedia contents by participating in the collusion attack.

It will be apparent to those skilled in the art that various modifications and variations can be made in the present invention. Thus, it is intended that the present invention covers the modifications and variations of this invention provided they come within the scope of the appended claims and their equivalents.

What is claimed is:

1. A fingerprint code structure comprising:
a contents code for indexing a contents itself; and
a customer code for having an index location representing a customer and remained locations.

2. The fingerprint code structure of claim 1, wherein the contents code is used as a signal mark for proving insertion of the fingerprint code when the customer codes are eliminated.

3. The fingerprint code structure of claim 2, wherein the contents code is located in a front of the customer code, in a back of the customer code or in middle of the customer code.

4. The fingerprint code structure of claim 1, wherein ‘0’ is inserted to the index location in the customer code and ‘1’ is inserted to the remained locations in the customer code.

5. A method for identifying collusion customers by using a fingerprint code, the method comprising the steps of:
a) inserting a contents code having same value to identical contents;
b) extracting the contents code from the contents and using the extracted contents code as a signal mark for determining whether a customer code is included in the contents; and
c) determining all customers as collusion customers participating in the collusion attack when the contents only includes the contents code.

6. The method of claim 5, wherein the contents code is used as the signal mark for proving insertion of the fingerprint code when the customer code is completely eliminated.

7. The method of claim 6, wherein the contents code is located in front of the customer code, in back of the customer code or in middle of the customer code.

8. A method for identifying collusion customers by using a fingerprint code, the method comprising the steps of:
a) inserting a customer code having different value in a contents;
b) extracting the customer code;
c) indexing a customer to a location of undetectable code in the customer code; and
d) identifying collusion customers by using locations of undetectable code from the contents where the customer code is eliminated by the collusion attack.

9. The method of claim 8, wherein ‘0’ is inserted to an index location of the customer code and ‘1’ is inserted to all remained locations of the customer code.

10. A method for identifying collusion customers by using a fingerprint code, the method comprising the steps of:
a) inserting a fingerprint code including a contents code and a customer code in a contents;
b) extracting the fingerprint code;
c) determining whether there is an collusion attack on the contents by using the extracted fingerprint code; and
d) identifying the collusion customers participating in the collusion attack according to a result of the determination.

11. The method of claim 10, wherein the contents code is used as a signal mark for proving insertion of the fingerprint code when the customer code is all eliminated from the contents.

12. The method of claim 11, wherein the contents code is located in front of the customer code, in back of the customer code or in middle of the customer code.

13. The method of claim 10, wherein ‘0’ is inserted to an index location of the customer code and ‘1’ is inserted to all remained locations of the customer code.
